(19) United States
(12) Patent Application Publication
(10) Pub. No.: US 2009/0139406 A1
(43) Pub. Date: Jun. 4, 2009

(54) DISCHARGE ELECTRODE AND METHOD FOR ENHANCEMENT OF AN ELECTROSTATIC PRECIPITATOR

(75) Inventors: Robert Warren Taylor, Ponte Vedra Beach, FL (US); Abdelkrim Younsi, Ballston Lake, NY (US); Yingneng Zhou, Niskayuna, NY (US); David Fulton Johnston, Poquoson, VA (US); Terry Lewis Farmer, Kearney, MO (US); J. Easel Roberts, Kansas City, MO (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/339,332

(22) Filed: Dec. 19, 2008

Related U.S. Application Data
(63) Continuation-in-part of application No. 11/326,306, filed on Jan. 4, 2006, now abandoned.

(51) Int. Cl. B03C 3/00; G06F 7/60; G06F 17/50

(52) U.S. Cl. 96/80; 703/2; 703/1

(57) ABSTRACT

A method for designing a discharge electrode of an electrostatic precipitator, includes:
selecting a base design for the discharge electrode and the electrostatic precipitator;
loading the base design into a computational tool for modeling collection efficiency, η, of the electrostatic precipitator as a function of at least one of a charging volume, V_{c}, a charging electric field, E_{c}, and an electric field for charged particle, E_{acc}; modeling the collection efficiency, η; and adjusting at least one aspect of the base design to improve the collection efficiency, η, according to the modeling.

### CROSS REFERENCE TO RELATED APPLICATION

This application is a continuation in part application of U.S. Ser. No. 11/326,306 filed Jan. 4, 2006, the contents of which are incorporated by reference herein in their entirety.

### BACKGROUND OF THE INVENTION

1. Field of the Invention

This invention relates generally to electrostatic precipitators, and more specifically to techniques for improving the collection efficiency thereof.

2. Description of the Related Art

Many industrial facilities require devices for limiting environmental emissions of particulate materials. A well-known device is the electrostatic precipitator. Electrostatic precipitators are commonly used in the electric utility industry at power production facilities (to limit emission of combustion by-products). Other examples of industries using electrostatic precipitators include those fabricating cement (dust), pulp and paper products (salt cake and lime dust), petrochemicals (for various mists), and steel (dust and fumes).

Electrostatic precipitators direct a stream of particle-laden gases through a collector chamber. The collector chamber contains electrodes that act as particle collectors. In a typical design, discharge electrodes are electrically insulated from the rest of the chamber and charged electrically. The electrical charge ionizes the suspended particles, causing them to move toward the collecting electrodes. A variety of collection devices may be employed to trap and remove the particles from the stream.

In the electrostatic precipitator, particles become negatively charged as a result of the negative discharge corona generated at the discharge electrode. The corona occurs when high voltage is applied to the discharge electrode. The precipitating process results from two simultaneous events: charging of the particles or co-mingling of the particles with other charged particles and attracting of charged particles under the applied electric field.

Electrostatic precipitators typically have a high efficiency rating. However, in some instances, electrostatic precipitators do not work as well as is desired. For example, electrostatic precipitators are not as effective with discharge streams having particles with a high electrical resistivity. Further challenges to the efficiency arise as users increase flow rates through the collection chamber in order to meet increased production (discharge) needs.

What is needed is a technique to improve the collection efficiency of an electrostatic precipitator. Preferably, this is accomplished through improved geometry for the discharge electrode without increasing the available collecting plate area.

### BRIEF DESCRIPTION OF THE INVENTION

In one embodiment, the invention includes a method for designing a discharge electrode of an electrostatic precipitator, the method including: selecting a base design for the discharge electrode and the electrostatic precipitator; loading the base design into a computational tool for modeling collection efficiency, η, of the electrostatic precipitator as a function of at least one of a charging volume, V_{c}, a charging electric field, E_{c}, and an electric field for charged particle, E_{acc}; modeling the collection efficiency, η; and adjusting at least one aspect of the base design of the discharge electrode to improve the collection efficiency, η, according to the modeling.

In another embodiment, the invention includes logic stored on computer readable media and including computer executable instructions for designing a component of an electrostatic precipitator, the product including instructions for: modeling a design of at least one feature of the component as a function of at least one of a charging volume, V_{c}, a charging electric field, E_{c}, and an electric field for charged particle, E_{acc}; and outputting results of the modeling to a user for adjusting the design of the component.

In a further embodiment, the invention includes a electrostatic precipitator exhibiting a collection efficiency, η, the precipitator including: a component including features adapted from a base design according to results obtained by modeling the collection efficiency, η, as a function of at least one of a charging volume, V_{c}, a charging electric field, E_{c}, and an electric field for charged particle, E_{acc}.

### BRIEF DESCRIPTION OF THE DRAWINGS

Referring now to the drawings wherein like elements are numbered alike in the several figures, wherein:

FIG. 1-1 through FIG. 1-7, collectively referred to herein as FIG. 1, depict cross sections of a potential field for a electrostatic precipitator;

FIG. 2 depicts aspects of an electrostatic precipitator with a V-Pin discharge electrode;

FIG. 3 depicts aspects of a quad blade discharge electrode;

FIG. 4-1 and FIG. 4-2, collectively referred to as FIG. 4, depict aspects of the discharge electrode and the stiffener, respectively;

FIG. 5-1 and FIG. 5-2, collectively referred to herein as FIG. 5, depict aspects of electrical fields within an electrostatic precipitator that implements the teachings herein;

FIG. 6 depicts aspects of a V-Pin discharge electrode developed in accordance with the teachings herein;

FIG. 7-1 and FIG. 7-2, collectively referred to as FIG. 7, depicts a dual blade discharge electrode;

FIG. 8-1 and FIG. 8-2, collectively referred to as FIG. 8, depicts a quad blade discharge electrode;

FIG. 9-1 and FIG. 9-2, collectively referred to as FIG. 9, depicts an angle configuration discharge electrode;

FIG. 10-1 and FIG. 10-2, collectively referred to as FIG. 10, depicts a star configuration discharge electrode;

FIG. 11-1 and FIG. 11-2, collectively referred to as FIG. 11, depicts an aero configuration discharge electrode;

FIG. 12-1 and FIG. 12-2, collectively referred to as FIG. 12, depicts a roll formed discharge electrode;

FIG. 13-1 and FIG. 13-2, collectively referred to as FIG. 13, depicts a quad pin discharge electrode; and,

FIG. 14 is a table of results from finite element analysis of various designs for a V-Pin style electrode.

### DETAILED DESCRIPTION THE INVENTION

The teachings herein provide embodiments of rigid discharge electrodes as well as electrostatic precipitators making use of the rigid discharge electrodes. Included are methods for designing the rigid discharge electrodes.

In general, each of the rigid discharge electrodes is disposed within a respective electrostatic precipitator. Each of the rigid discharge electrodes is designed to provide improved migration velocity and therefore collection efficiency for particles within the electrostatic precipitator. Design of the rigid discharge electrodes is generally accomplished by use of finite element analysis (or other similar techniques) to provide for fine control over electrical fields within the electrostatic precipitator(s).

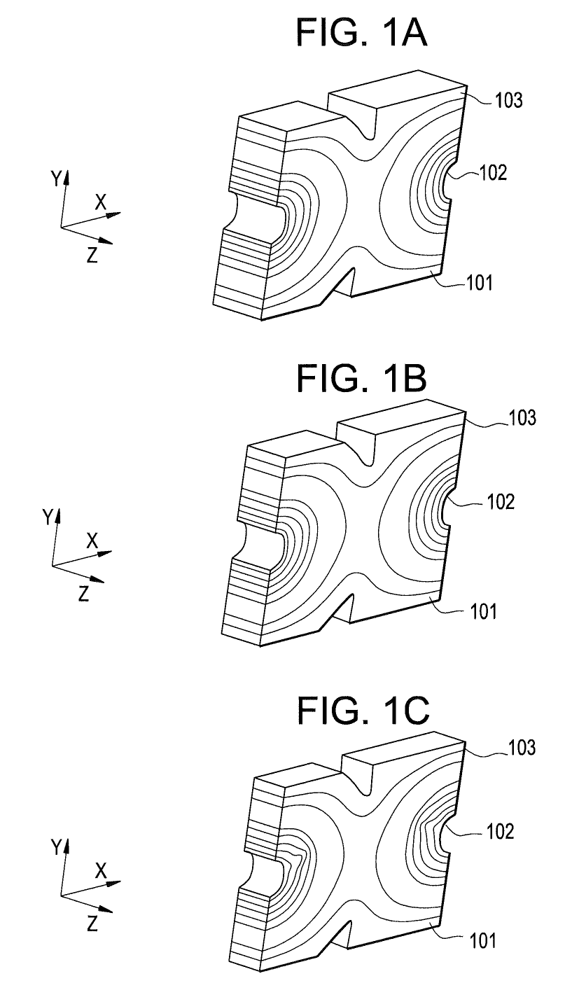

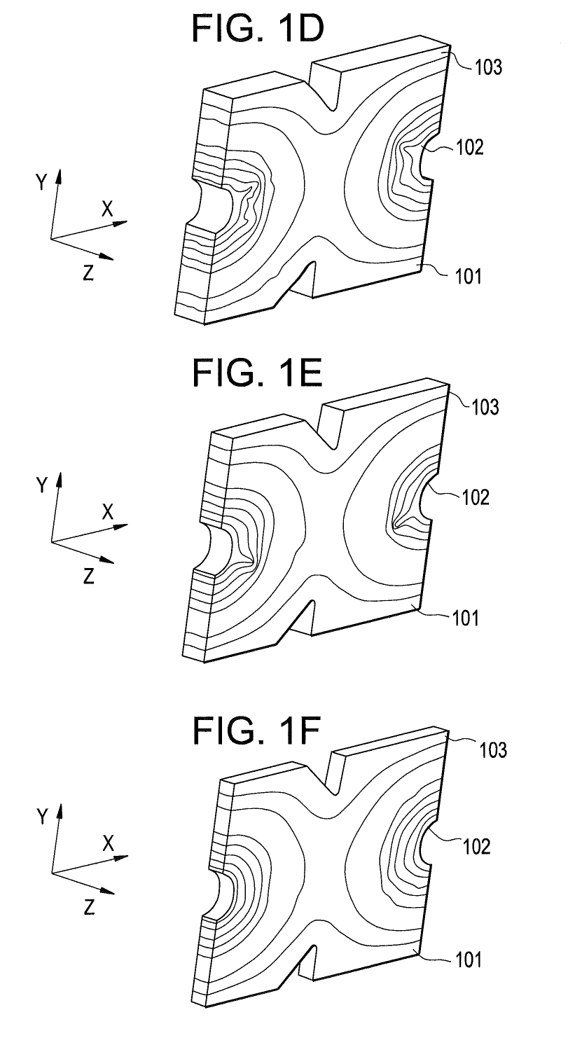

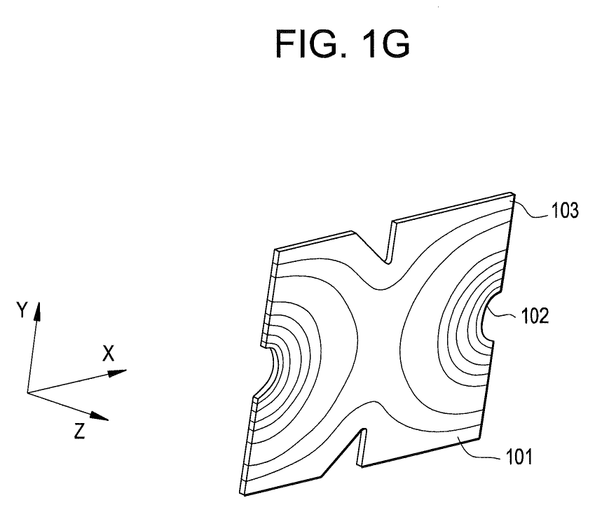

Now to provide some context, and with reference to FIG. 1, there is shown a plot of electric potential 101 over a portion of an electrostatic precipitator. The potential field is shown in various “slices” from the electrostatic precipitator, where FIG. 1-1 is a first slice, and FIG. 1-7 shows the last slice. In each of the slices, equipotential lines are shown which define a given range of voltage within an electrostatic precipitator (note that FIG. 1 does not depict any apparatus).

In this mapping of the potential 101, each slice includes a region of highest potential 102, and a region having a lowest potential 103, and various regions in between. Each region of highest potential 102 generally surrounds an electrode (not shown), while each region of lowest potential 103 is nearest to collecting plates (not shown) of the electrostatic precipitator (not shown).

As can be seen with reference to the various slices, the potential field 101 is not uniform. That is, for example, the region of highest potential 102 shown in FIGS. 1-4 and 1-5 has certain irregularities as may be associated with a shape of a given electrode. Such irregularities are better seen when comparing the region of highest potential 102 in FIGS. 1-4 and 1-5 with the region of highest potential 102 shown in FIGS. 1-1 and 1-7.

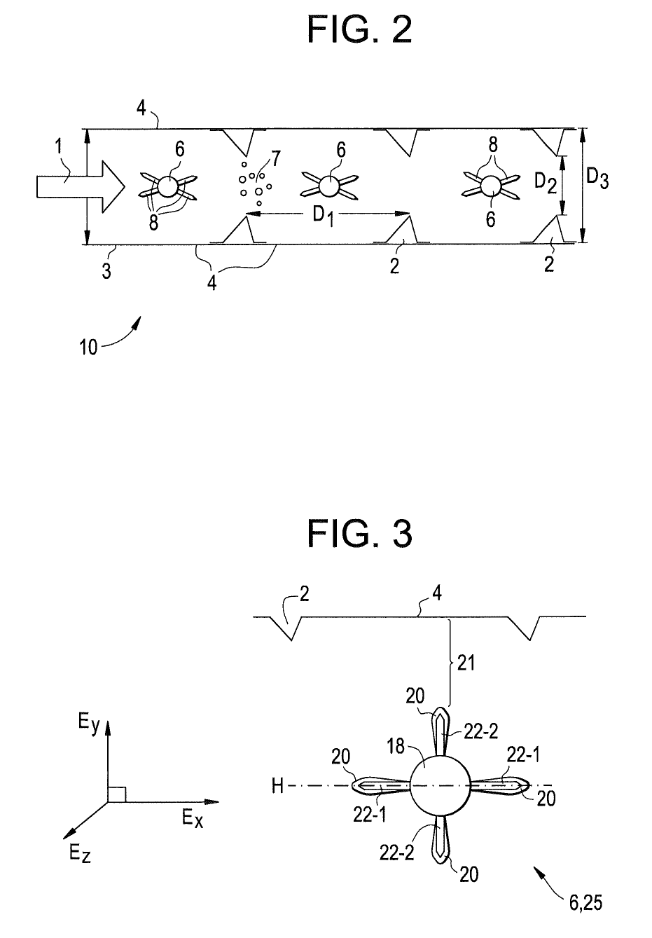

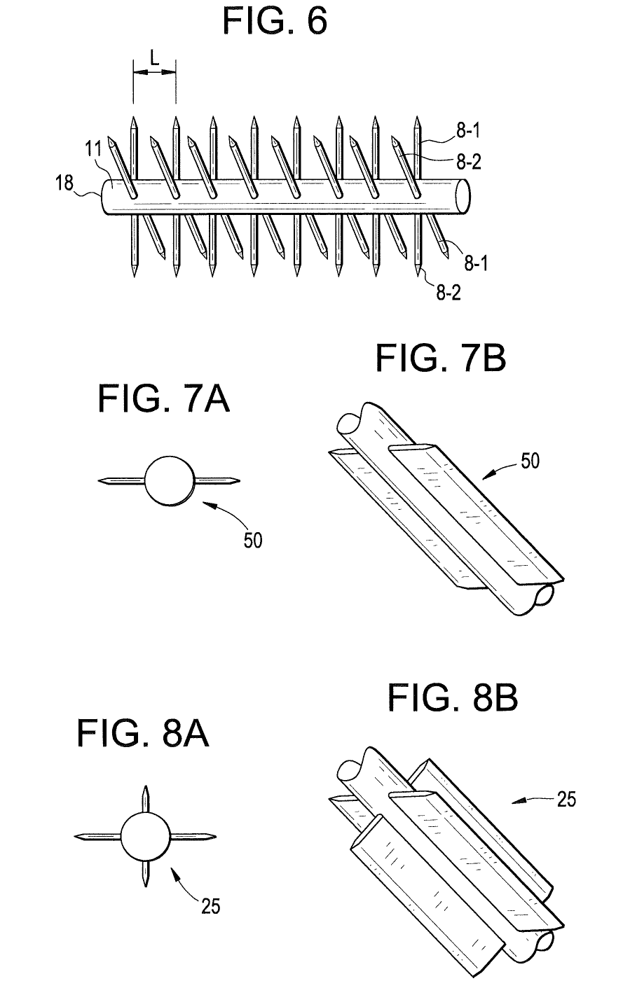

Referring now to FIG. 2, there is shown an exemplary embodiment of an electrostatic precipitator 10 including improvements as disclosed herein. The electrostatic precipitator 10 is generally a planar structure that includes a series of parallel and generally flat collecting plates 4 more or less evenly spaced, with discharge electrodes 6 located periodically between the collecting plates 4. In this embodiment, each of the discharge electrodes 6 is depicted as a V-Pin electrode. The V-Pin electrode generally includes a center tube that supports at least two-pins in a V shaped arrangement. Another view of the V-Pin electrode is provided in FIG. 6.

Referring still to FIG. 2, included in the electrostatic precipitator 10 may be one or more up to a series of stiffeners 2. During operation, the collecting plates 4 attract and collect particles 7 entrained in the emission gas 1. As is known in the art, a potential (of a high voltage), V, is applied across the discharge electrodes 6 and the collecting plates 4 to generate an electric field, E. Once in the electric field, E, the particles 7 generally become negatively charged and migrate toward the collecting plates 4 (also referred to as “collecting electrodes 4”). This migration occurs, at least in part, as a result of the negative discharge corona (not shown) generated at the discharge electrode 6.

As used herein, the term “particles” refers to any material, or materials, entrained in a gas, fume or other media for which an electrostatic precipitator 10 may be used to reduce the concentrations thereof. Accordingly, as used herein, particles 7 should be considered to be a general and non-limiting term. For example, particles 7 may be included in materials that might be classified as one of dust, fumes, gas and a mist.

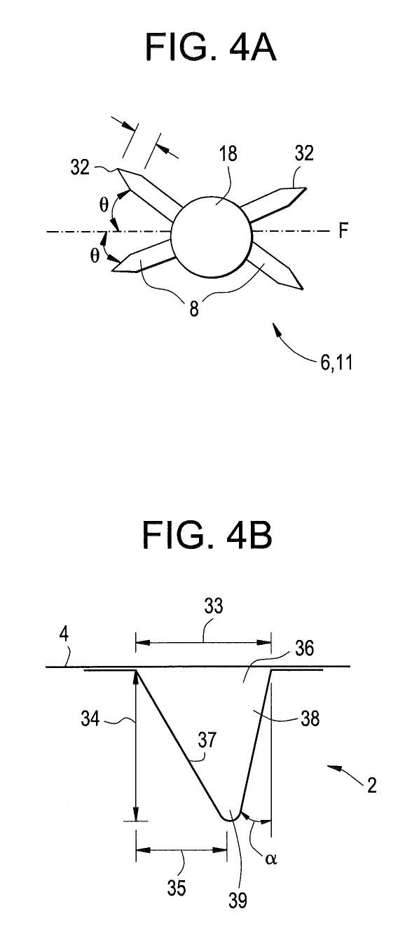

In FIG. 2, the discharge electrode 6 has been enhanced with a series of pins 8. In the embodiment depicted, each discharge electrode 6 includes four series of the pins 8. This configuration of the discharge electrode 6 is discussed later herein with greater detail in reference to FIG. 4.

Selecting dimensions of the pins 8 is one example of selecting physical aspects of the discharge electrode 6 in order to manipulate the electric field and thus improve the collection efficiency of the electrostatic precipitator 10. That is, when voltage, V, is applied to the discharge electrode 6, the pins 8 provide for generation of the electric field, E, having properties that result in improved collection efficiency. It should be noted that aside from the improving collection efficiency, this benefit does not require increasing the area of the collecting plates 4.

As a matter of convention, the electric potential 101 is the potential energy per unit of charge that is associated with a static (time-invariant) electric field, E. In various embodiments, the potential 101 is measured in volts. A difference in the potential 101 between the electrodes and the collecting plates is referred to as the voltage. The electric field, E, exerts a force on charged particles entrained in the flow, accelerating them in the direction of the force, in either the same or the opposite direction of the electric field, E, depending on the charge.

Aside from modifying aspects of the discharge electrode 6, a variety of dimensions may be modified to assist with improving the collection efficiency. Exemplary dimensions that may be varied include, without limitation, the distance between the stiffeners 2, (shown as D₁ and referred to as the “stiffener spacing”); the gas passing width D₃; the baffle spacing D₂; and, the shape and size (including varying height and width ratios) of the stiffeners 2. Further aspects of the electrostatic precipitator 10 that may be varied include placement of features such as the stiffeners 2 in relation to the discharge electrode 6. In short, any other aspects of the geometry and relationships of features of the electrostatic precipitator 10 may be varied in conjunction with the design of the discharge electrode 6 to provide for improved collection efficiency.

In order to better characterize improvements to the collection efficiency, it is important to understand certain relationship. Increases in migration velocity result in large changes in the collection efficiency of the particles 7. This relationship is described by the algorithm given generally in Eq. 1 (referred to as the “Deutsch Anderson” equation):

η=1−ₑ^{(-A/Q)ω} (Eq. 1)

wherein

η represents the collection efficiency;

ω represents the particle migration velocity;

A represents the area of the collection electrode; and,

Q represents the flow rate of the gas.

Migration velocity is further defined as:

ω=(EₒEₚa)/(2πh) (Eq. 2)

wherein

ω represents the particle migration velocity (meters/second);

Eₒ represents the charging electric field (volts/meter);

Eₚ represents the collecting electric field (volts/meter);

a represents the particle size (meters);

π represents a constant, pi, having a value of approximately 3.14; and,

h represents the viscosity of the gas (kilograms/meters-seconds).

Note that Eq. 2 describes aspects of particle 7 migration in a uniform electric field, E. For cases of non-uniform electric fields, E, such as those encountered in a duct-type of electrostatic precipitator 10, Eₒ and Eₚ are defined according to Eq. 3 and Eq. 4, respectively.

$$\begin{matrix}{E}_{o} = Average ( \sqrt{{E}_{x}^{2} + {E}_{y}^{2} + {E}_{z}^{2}} ) & ( Eq . 3 ) \\ {E}_{p} = Average ( \sqrt{{E}_{x}^{2} + {E}_{y}^{2}} ) ; & ( Eq . 4 )\end{matrix}$$

where, for small stiffeners 2, Eₚ may be determined as provided by Eq. 5:

Eₚ=Average(|E_{y}|) (Eq. 5);

wherein:

Eₓ represents the average electric field in the X direction;

E_{y} represents the average electric field in the Y direction;

E_{z} represents the average electric field in the Z direction; and,

Average represents the average value over the entire space between the discharge electrode 6 and the collecting plates 4.

These relationships can be simplified and better understood, when considered in conjunction with the embodiment depicted in FIG. 3. The embodiment of the discharge electrode 6 depicted in FIG. 3 is referred to as a “quad blade electrode 25.” For the quad blade electrode 25, strips of metal 22 were applied along the surface of a round tube 18 to create the discharge electrode 6. The strips of metal 22 were each offset about 90 degrees from the other strips of metal 22. Two of the strips of metal, referred to herein for convenience as “major strips 22-1” were generally greater in size than the “minor strips 22-2.” The major strips 22-1 were placed in parallel with the general flow of the emission gas 1.

In the embodiment depicted, each of the strips of metal 22 includes a small region that is referred to as the “high field region”, or the charging region 20. In this embodiment, the charging region 20 is the region where the electric field is typically higher than 30 kV/cm. Also depicted in FIG. 3 is a low field region, also referred to as a migration space 21, where the electric field is typically lower than 30 kV/cm. In some embodiments, the small region of the strips of metal 22 is sharpened (e.g., to a knife-edge) to provide for improved corona.

FIG. 4-1 and FIG. 4-2, collectively referred to as FIG. 4, provide a more detailed example of improvements to the discharge electrode 6. This embodiment, referred to as a V-Pin electrode 11. In the non-limiting embodiment depicted in FIG. 3-1, each of the pins 8 is about 1.5 inches (3.81 cm) in overall length. In this example, the cross section of each of the pins 8 is of a round appearance, and about 0.134 inches (0.34 cm) in diameter. Further, each pin 8 depicted includes a pointed tip 32. In this embodiment, the pointed region of the tip 32 is about 0.1875 inches (0.48 cm) in length, as depicted by the dimensional arrows in FIG. 4-1. In this embodiment, the round tube 18 at the center of the V-Pin electrode 11 is about 1.5 inches (3.81 cm) in diameter. In the embodiment depicted of the V-Pin electrode 11, the series of pins 8 are offset at an angle theta (θ) from a plane F bisecting the V-Pin electrode 11 and consistent with the direction of flow. In this example, the offset angle theta (θ) is substantially less than 90 degrees and closer to about 30 degrees.

Referring also to FIG. 4-2, shape and size of the stiffener 2 may be modified to improve the collection efficiency of the electrostatic precipitator 10. As one example, for the V-Pin electrode 11 depicted in FIG. 4-1, the stiffener 2 includes a base 36, a forward side 38, a stiffener tip 39 and an aft side 37. The stiffener tip 39 is located at an angle alpha (α) of about four degrees aft of the base 36 on the forward side 38. The base 36 on the aft side 37 about 2.7 inches (6.7 cm) aft of the stiffener tip 39. The overall height of the stiffener 2 (distance of the stiffener tip 39 from the base 36) is about 1.9 inches (4.826 cm).

In some embodiments, the V-Pin electrode 11 is located about halfway between each discharge electrode 6, and about halfway between each stiffener 2, as depicted in FIG. 1. For the embodiment presented in FIG. 4, each stiffener 2 is about 18.875 inches (47.93 cm) apart, when measured from stiffener tip 39 to next successive stiffener tip 39. Also for this embodiment, the gas passing width D₃ is about 11 inches (27.94 cm).

Referring also to FIG. 6, further dimensions related to this embodiment include the lateral spacing L of the pins 8 along the rounded tube 18. In this example, the lateral spacing L of the pins 8 is about 3 inches (7.62 cm), while the distance between the base of a first pin 8-1 from a second pin 8-2 in each V is about 0.5 inches (1.27 cm) along the circumference of the rounded tube 18.

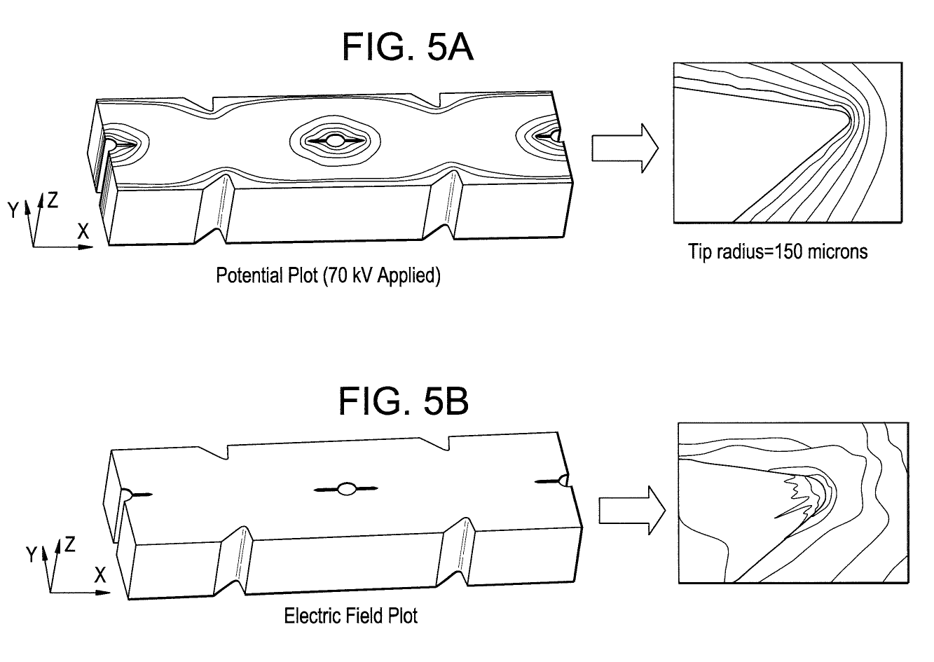

Referring now to FIG. 5-1 and FIG. 5-2, collectively referred to as FIG. 5, electrical properties of the electrostatic precipitator 10 are shown. In FIG. 5-1, a plot of the electric potential field 101 is shown. In this example, components of the electrostatic precipitator 10 are designed such that the potential field 101 is results in an electric field (FIG. 5-2) that generally provides an electric force that results in increased migration velocity, ω, of the particles 7.

In operation, flue gas rich with particulate matter enters duct space of the electrostatic precipitator 10 at a certain velocity. Electrons are produced at respective portions of each rigid discharge electrode (such as the tip). That is, the electrons are produced where the electric field is greater than an air ionization field of about 30 kV/cm. The dust and gas interact with the corona discharge and the dust particles get negatively charged by electron and ion attachment. Accordingly, a charging volume, V_{c}, is defined herein as the volume where the electric field strength exceeds 30 kV/cm.

As one might surmise, the dust electrostatic charging process is a function of the electric strength and particle size. Generally, it is assumed that the particles are all being fully charged and the charge increases with the local electric field strength around each particle. This electric field is the total field in all directions (Eₓ, E_{y}, E_{z}). Therefore, a charging field, E_{c}, is defined as the average electric field, Eₐᵥₑ, in all directions and over the entire duct space within the electrostatic precipitator.

Accordingly, the collection efficiency, η, becomes a function of a charging volume, V_{c}, charging electric field, E_{c}, and an electric field for charged particle acceleration, E_{acc}. At least some aspects are provided in Eqs. (6-8) below.

η=f(V_{c},E_{c},E_{acc}) (Eq. 6).

E_{c}=Avg(Eₓ²+E_{y}²+E_{z}²)^{1/2} (Eq 7);

where charging is proportional to the average field higher than air ionization (30 kV/cm). Each of the components of the electric field, E, (that is, Eₓ, E_{y}, and E_{z}) contribute to ionization. It should be noted, however, that acceleration toward the collection plates is generally proportional to only the X and Y components (Eₓ and E_{y}), and E_{z} is negligible. Once the particles are charged, they begin a drift and migration process towards the grounded collecting plates. The migration force, and therefore migration velocity, is proportional to the particle charge and the local electric field in the directions of the collecting plates and stiffeners only. Thus, the acceleration field, E_{acc}, is described by Eq. 8:

E_{acc}=Avg(Eₓ²+E_{y}²)^{1/2} (Eq. 8).

Having thus described relationships for particle migration, certain aspects of design are discussed. In some embodiments, numerical techniques are used to identify improved designs for each of the rigid discharge electrode, the collecting plates, and any other components of the electrostatic precipitator, alone or in combination. Generally, such numerical techniques are implemented using known design tools, such as finite element analysis (FEA) and the like. As used herein, tools for FEA and the like generally provide computationally robust techniques for finding approximate solutions to complex problems, such as those having partial differential equations (PDE) as well as those based on integral equations. The computational tools, generally speaking, simplify the analysis, such as by eliminating the differential equation completely, or rendering the PDE into an approximating system of ordinary differential equations, which are then numerically integrated using standard numerical techniques. One example of modeling performance of the electrostatic precipitator is provided.

In one embodiment, logic (that is, instructions for use by a computational tool, such as a processor, or as another example, a computer program product that includes computer executable instructions stored on computer readable media) is used to provide for finite element analysis. In some embodiments, the logic may also be referred to as “software.” One example of suitable software is provided by ANSYS of Canonsburg, Pa., and supports three-dimensional (3D) modeling. This software, and other computational tools are readily available for providing users with suitable analysis capabilities.

In embodiments modeled, a variety of inputs were used. As non-Limiting examples, geometric features and dimensions of the electrostatic precipitator 10 were used to create a solid model. In some embodiments, and in order to limit the size of the model and reduce the computing time, a limited but representative section of the electrostatic precipitator 10 is modeled.

Once the model has been constructed, the model is then subdivided into elements using a meshing process. This process allows the creation of millions of elements to be used in the computational process. The material properties such as conductivity and permittivity are incorporated into the model together with the boundary conditions such as voltages on the electrodes and the collecting plates. Once the model is solved, the electric field and the equipotential lines are plotted in both two-dimensions (2D) and three-dimensions (3D). The overall solution may be used to calculate integrated values of V_{c}, E_{c} and E_{acc}.

In other embodiments, non-limiting and exemplary aspects such as conductivity, permittivity, resistivity, charge, flow rate, properties of entrained particles, temperature, pressure, voltage, current, build-up of particulate matter and the like are considered in the modeling.

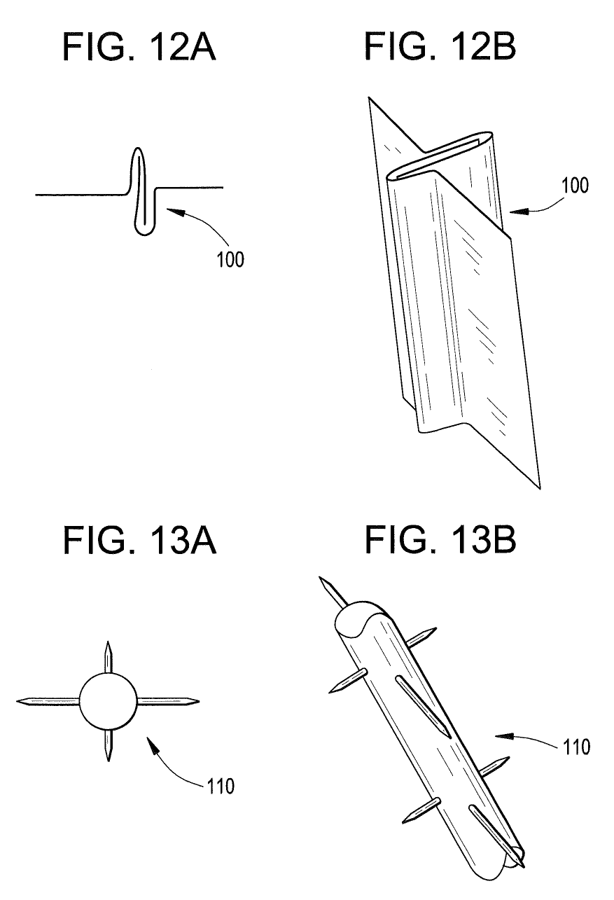

It should be noted that the V-Pin electrode 11 and the quad blade electrode 25 are only two of the many other embodiments for the discharge electrode 6. Other exemplary embodiments are depicted in FIGS. 7-13.

Referring to FIG. 5-1 and FIG. 5-2, collectively referred to as FIG. 5, there is shown a dual blade electrode 50. FIG. 5-1 depicts a cross section of the dual blade electrode 50, while FIG. 5-2 provides an angular view of the dual blade electrode 50.

Referring to FIG. 6-1 and FIG. 6-2, collectively referred to as FIG. 6, there is shown the quad blade electrode 25. FIG. 6-1 depicts a cross section of the quad blade electrode 25, while FIG. 6-2 provides an angular view of the quad blade electrode 25.

Referring to FIG. 7-1 and FIG. 7-2, collectively referred to as FIG. 7, there is shown an angle configuration electrode 70. FIG. 7-1 depicts a cross section of the angle configuration electrode 70, while FIG. 7-2 provides an angular view of the angle configuration electrode 70. Note that the angle configuration electrode 70 does not include the round tube 18.

Referring to FIG. 8-1 and FIG. 8-2, collectively referred to as FIG. 8, there is shown a star configuration electrode 80. FIG. 8-1 depicts a cross section of the star configuration electrode 80, while FIG. 8-2 provides an angular view of the star configuration electrode 80. Note that the star configuration electrode 80 does not include the round tube 18.

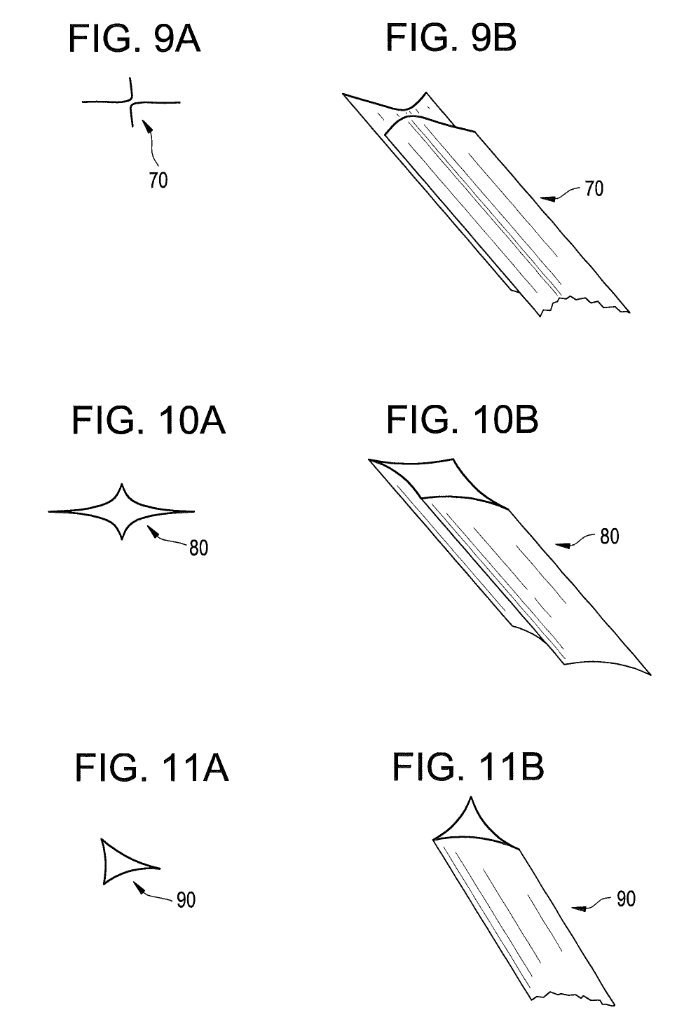

Referring to FIG. 9-1 and FIG. 9-2, collectively referred to as FIG. 9, there is shown an aero configuration electrode 90. FIG. 9-1 depicts a cross section of the aero configuration electrode 90, while FIG. 9-2 provides an angular view of the aero configuration electrode 90. Note that the aero design electrode 90 does not include the round tube 18.

Referring to FIG. 10-1 and FIG. 10-2, collectively referred to as FIG. 10, there is shown a roll formed configuration electrode 100. FIG. 10-1 depicts a cross section of the roll formed configuration electrode 100, while FIG. 10-2 provides an angular view of the roll formed configuration electrode 100. Note that the roll formed configuration electrode 100 does not include the round tube 18.

Referring to FIG. 11-1 and FIG. 11-2, collectively referred to as FIG. 11, there is shown a quad pin electrode 110. FIG. 11-1 depicts a cross section of the quad pin electrode 110, while FIG. 11-2 provides an angular view of the quad pin electrode 110.

In summary, one can generally refer to these non-limiting examples of improved discharge electrodes 6 as having “features” that improve the particle 7 migration velocity (ω). As taught herein, these features provide for improved electric field properties across the migration space 21.

Accordingly, it should be obvious to one skilled in the art that the features may be attached to existing aspects of the discharge electrode 6 (for example, the round tube 18 as a retrofit to existing technology), may replace existing discharge electrodes 6 entirely (for example, during a system overhaul), or may be used in addition to existing discharge electrodes 6. Of course, design of the electrostatic precipitator 10 may take advantage of the teachings herein to provide for an improved electric field and, thus, modify other aspects of the electrostatic precipitator 10. For example, the size, shape and placement of the stiffeners 2 may be considered and designed to work in conjunction with the discharge electrode 6 incorporating such features.

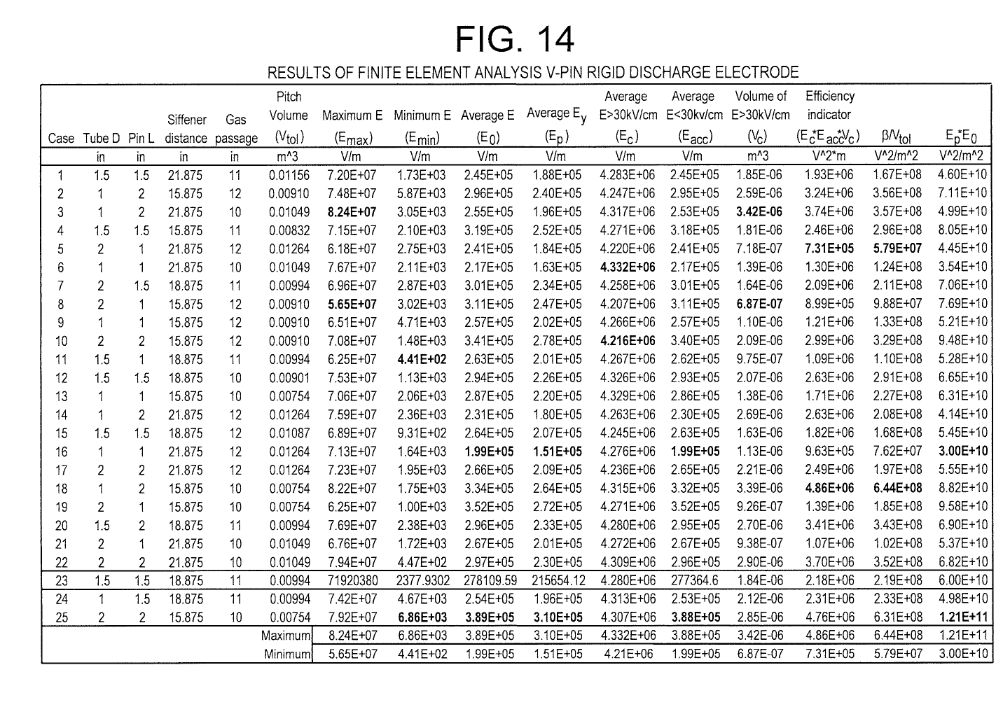

FIG. 14 includes results of finite element analysis for evaluation of a V-Pin style rigid discharge electrode. In this table of results, Case 23 provides a base design. As can be seen by review of the maximum and minimum values, certain embodiments appear to be more promising for improving collection efficiency than others.

Accordingly, it should be recognized that improved designs resulting from analyzed and modified base designs by implementation of the teachings herein, will result in improved collection efficiency, η, increased migration velocity, ω, for a given electrostatic precipitator. Accordingly, improved reductions in emissions, reduced operating costs (such as from electric load) and other such benefits are realized.

One skilled in the art will recognize that the teachings herein may be employed prospectively, such as during the design phase, or retrospectively, as in this case where testing of design was undertaken.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A method for designing a discharge electrode of an electrostatic precipitator, the method comprising:
selecting a base design for the discharge electrode and the electrostatic precipitator;
loading the base design into a computational tool for modeling collection efficiency, η, of the electrostatic precipitator as a function of at least one of a charging volume, V_{c}, a charging electric field, E_{c}, and an electric field for charged particle acceleration, E_{acc};
modeling the collection efficiency, η; and
adjusting at least one aspect of the base design of the discharge electrode to improve the collection efficiency, η, according to the modeling.

2. The method of claim 1, further comprising adjusting at least one aspect of another component of the electrostatic precipitator to improve the collection efficiency, η.

3. The method of claim 2, wherein adjusting comprises modifing at least one of a material, a geometry, a dimension, an operational voltage and an operational current.

4. The method of claim 2, wherein the another component comprises one of a collecting plate, a stiffener and a duct size.

5. The method of claim 1, wherein the loading comprises inputting information comprising at least one of a geometry, a dimension, conductivity, permittivity, resistivity, charge, flow rate, properties of entrained particles, temperature, pressure, voltages, current, build-up of particulate matter within the electrostatic precipitator; a collection efficiency, a particle migration velocity, an area of the collecting electrode, an average electric field across a particle migration space, a local electric field at the collecting electrode, and a viscosity of gas.

6. The method of claim 1, wherein modeling comprises performing finite element analysis.

7. The method of claim 1, wherein the modeling comprises modeling in one of two-dimensions (2D) and three-dimensions (3D).

8. The method of claim 1, further comprising deriving additional components for the electrostatic precipitator from the results.

9. The method of claim 8, wherein deriving comprises at least one of retrofitting, adding and replacing.

10. The method of claim 1, wherein the aspect comprises at least one of a size, a shape and a relative placement of a stiffener of the electrostatic precipitator.

11. The method of claim 1, wherein the modeling is performed for a portion of the electrostatic precipitator.

12. Logic stored on computer readable media and comprising computer executable instructions for designing a component of an electrostatic precipitator, the product comprising instructions for:
modeling a design of at least one feature of the component as a function of at least one of a charging volume, V_{c}, a charging electric field, E_{c}, and an electric field for charged particle acceleration, E_{acc}; and
outputting results of the modeling to a user for adjusting the design of the component.

13. The logic as in claim 12, wherein the modeling comprises performing finite element analysis.

14. The logic as in claim 12, wherein the component comprises one of a discharge electrode, a collecting plate, a stiffener and a duct.

15. The logic as in claim 12, wherein the modeling receives as an input at least one of: a geometry, a dimension, conductivity, permittivity, resistivity, charge, flow rate, properties of entrained particles, temperature, pressure, voltages, current, build-up of particulate matter within the electrostatic precipitator, a collection efficiency, a particle migration velocity, an area of the collecting electrode, an average electric field across a particle migration space, a local electric field at the collecting electrode and a viscosity of gas.

16. The logic as in claim 12, wherein adjusting comprises modifing at least one of a material, a geometry, a dimension, an operational voltage and an operational current.

17. An electrostatic precipitator exhibiting a collection efficiency, η, the precipitator comprising:
a component comprising features adapted from a base design according to results obtained by modeling the collection efficiency, η, as a function of at least one of a charging volume, V_{c}, a charging electric field, E_{c}, and an electric field for charged particle acceleration, E_{acc}.

18. The electrostatic precipitator of claim 17, wherein the component comprises at least one of a collecting plate, a discharge electrode, a stiffener and a duct.

19. The electrostatic precipitator of claim 17, wherein the discharge electrode comprises one of a dual blade electrode, a quad blade electrode, an angle configuration electrode, a star configuration electrode, an aero configuration electrode, and a roll formed configuration electrode.

20. The electrostatic precipitator of claim 17, wherein the component comprises at least one of a sharpened edge and a sharpened point.
